(19) United States
(12) Patent Application Publication
(10) Pub. No.: US 2024/0218480 A1
(43) Pub. Date: Jul. 4, 2024

(54) RECOVERY OF METALS FROM METALLIC OR METAL-BEARING MATERIALS

(71) Applicant: AFRICAN RAINBOW MINERALS LIMITED, Sandton (ZA)

(72) Inventor: Gerard Pretorius, Pretoria (ZA)

(21) Appl. No.: 18/553,389

(22) PCT Filed: Mar. 31, 2022
(86) PCT No.: PCT/IB22/53009

§ 371 Date: Sep. 29, 2023

(30) Foreign Application Priority Data
Mar. 31, 2021 (NL) 2027874

(51) Int. Cl. C22B 3/44; C22B 3/10

(52) U.S. Cl. CPC C22B 3/44; C22B 3/10

(57) ABSTRACT

A method of treating a metallic or metal-bearing material includes, in an oxidative or reductive digestion step, contacting the metallic or metal-bearing material with a reagent selected from ferric chloride (FeCl₃), hydrochloric acid (HCl), and a combination thereof, thus producing a ferrous chloride (FeCl₂) solution.

### FIELD OF THE INVENTION

THE INVENTION relates to the recovery of metals from solid metallic or metal-bearing materials. The invention provides a method of treating a solid metallic or metal-bearing material, to recover one or more metals from the metallic or metal-bearing material via a chloride medium. In this sense, “metal” has a broad meaning, including both metals in elemental metallic form and metal compounds. The invention extends to a process for performing the method.

### BACKGROUND TO THE INVENTION

IN MANY MINERAL CONCENTRATES, and other metallic and metal-bearing materials, iron is a major contaminant. Dealing with iron generally results in high acid consumption and waste generation when such materials are beneficiated using hydrometallurgical processes.

The present invention seeks to provide a more efficient and cost-effective approach, while not limiting itself to the beneficiation iron-contaminated metallic and metal-bearing materials.

### OBJECT OF THE INVENTION

IT IS AN OBJECT OF THE INVENTION to provide for the treatment of metallic or metal-bearing materials that contain metals other than iron and, optionally, also contain iron, the iron then typically being comprised by a matrix containing the other metals, to liberate such metals other than iron from such matrices. In this sense, again, “metal” has a broad meaning, including both metals in elemental metallic form and metal compounds. In respect of metal compounds, it is envisaged that such compounds would be in a form that may be more readily beneficiated than the original form in which such metals manifested in the metallic or metal-bearing material.

### SUMMARY OF THE INVENTION

IN THIS SPECIFICATION the provision of features in parenthesis contribute to the substantive content of the specification and therefore to the characterisation of the invention. In particular, in cases in which generic chemical formulae and numerical values for symbols of such generic formulae are provided in parenthesis, this should be interpreted as contributing substantively to the characterisation of the invention.

IN ACCORDANCE WITH A FIRST ASPECT OF THE INVENTION IS PROVIDED a method of treating a solid metallic or metal-bearing material, comprising one or more metals in metallic or compound form, to recover one or more of the metals from the metallic or metal-bearing material in metallic or compound form, the method including, in an oxidative or reductive digestion step, producing a ferrous chloride (FeCl₂) solution by contacting the metallic or metal-bearing material with a digestion reagent selected from
ferric chloride (FeCl₃), typically in aqueous solution,
gaseous hydrochloric acid (HCl),
HCl, in aqueous solution, and
optionally, a combination or any two or more thereof, and
reducing any FeCl₃ in solution, produced from the contacting of the metallic or metal-bearing material with the digestion reagent, to FeCl₂ in solution.

The contacting of the metallic or metal-bearing material with the digestion reagent may be performed in aqueous medium. Thus, the FeCl₂ solution may be an aqueous FeCl₂ solution.

When the digestion reagent is HCl, contacting the metallic or metal-bearing material with the HCl may include
contacting the metallic or metal-bearing material directly with gaseous HCl (i.e. not in the form of an aqueous HCl solution); or
contacting the metallic or metal-bearing material with HCl in aqueous solution, preferably of a concentration above 30% v/v, e.g. between 30% and 36% v/v, e.g. 33% v/v.

When contacting the metallic or metal-bearing material with gaseous HCl, the metallic or metal-bearing material may, in particular, be a hydrous ore material, which may be an ore material comprising chemically bound water (as opposed to “free water”, i.e. not chemically bound water), typically in a range of from about 5% to about 70% by weight, e.g. in the form of metal hydrates and/or metal hydroxides. Optionally, such a hydrous ore material may be slightly wetted with free water, e.g. up to about 5% by mass of the mass of the hydrous ore, before being subjected to digestion in the digestion step.

The gaseous HCl may, preferably, be anhydrous gaseous HCl, e.g. produced according to the third aspect of the invention.

When contacting the metallic or metal-bearing material with an aqueous HCl solution, the method may include
preparing an aqueous HCl solution by scrubbing gaseous HCl with water, and contacting the metallic or metal-bearing material with the aqueous HCl solution thus prepared; or
preparing an aqueous suspension or slurry of the metallic or metal-bearing material and scrubbing gaseous HCl with the suspension or slurry of the metallic or metal-bearing material.

The gaseous HCl may, in particular, be gaseous HCl, and more specifically anhydrous gaseous HCl, produced according to the third aspect of the invention.

Reducing FeCl₃ produced from the contacting of the metallic or metal-bearing material with the digestion reagent to FeCl₂ may be effected using a reducing agent, e.g. metallic iron (Fe).

Depending on the composition of the metallic or metal-bearing material, contacting the metallic or metal-bearing material with the digestion reagent may produce a solution of FeCl₃ to the exclusion of FeCl₂ or a solution comprising both FeCl₃ and FeCl₂, which would thus require reduction of the FeCl₃ to be effected using the reducing agent.

It is also possible that a solution comprising no FeCl₃ would be produced, in which case no reduction would be required.

It will be appreciated that reduction is therefore only required if the digestion of the metallic or metal-bearing material produces FeCl₃

The digestion reagent may therefore, for example, be
gaseous HCl, e.g. produced in accordance with the third aspect of the invention;
an aqueous solution of HCl, e.g. produced by scrubbing gaseous HCl produced in accordance with the third aspect of the invention with water;
an aqueous solution of HCl, e.g. produced by scrubbing gaseous HCl e.g. produced in accordance with the third aspect of the invention with an aqueous suspension or slurry of the solid metallic or metal-bearing material;
an aqueous solution of FeCl₃, e.g. produced by contacting solid hematite (Fe₂O₃), e.g. produced in accordance with the third aspect of the invention, with an aqueous solution of HCl produced by scrubbing gaseous HCl e.g. produced in accordance with the third aspect of the invention with water; or is an aqueous solution of FeCl₃, e.g. produced by scrubbing gaseous HCl e.g. produced in accordance with the third aspect of the invention with an aqueous suspension of solid Fe₂O₃, e.g. produced in accordance with the third aspect of the invention.

When the metallic or metal-bearing material comprises iron, in metallic or compound form, such iron would be converted to ferrous chloride as described above and thus be present as ferrous chloride in the FeCl₂ solution. When the metallic or metal-bearing material comprises metals (M) other than iron, in metallic or compound form, then at least some such metals other than iron would advantageously also be converted to soluble, e.g. divalent, chlorides (M²⁺Cl₂) thereof.

IN ACCORDANCE WITH A SECOND ASPECT OF THE INVENTION IS PROVIDED a method of treating a solid metallic or metal-bearing material, comprising one or more metals in metallic or compound form, to recover one or more of the metals from the metallic or metal-bearing material in metallic or compound form, the method including, in a displacement crystallisation step, contacting a FeCl₂ solution, typically an aqueous FeCl₂ solution, produced by oxidative/reductive digestion of the metallic or metal-bearing material, with a displacement crystallisation reagent, preferably HCl, most preferably gaseous HCl, that displaces FeCl₂ from the FeCl₂ solution and thus produces a solid ferrous chloride hydrate (FeCl₂·xH₂O, wherein x≥1, more preferably x>1), typically solid ferrous chloride tetrahydrate (FeCl₂·4H₂O, i.e. x=4).

The HCl in gaseous form may be anhydrous gaseous HCl.

The HCl in gaseous form that may be used in effecting the displacement crystallisation may, in particular, be HCl in gaseous form, and more specifically anhydrous HCl in gaseous form, produced in accordance with the third aspect of the invention.

Producing the FeCl₂ solution by oxidative/reductive digestion of the metallic or metal-bearing material may have included contacting the metallic or metal-bearing material with a digestion reagent selected from
FeCl₃, typically in aqueous solution,
gaseous HCl,
HCl, in aqueous solution, and
optionally, a combination of any two or more thereof, and
reducing any FeCl₃ in solution, produced from the contacting of the metallic or metal-bearing material with the digestion reagent, to FeCl₂.

The FeCl₂ solution may, for example, be a FeCl₂ solution that has been produced according to the digestion step of the first aspect of the invention.

As noted above, the FeCl₂·xH₂O may, in particular, be FeCl₂·4H₂O, i.e. x=4.

The displacement crystallisation step may include, or may more typically be followed by, a dehydration (i.e. drying) step, which may include subjecting the FeCl₂·xH₂O to temperature treatment to produce a dehydrated solid ferrous chloride hydrate (FeCl₂·yH2O, wherein x>y>0). The FeCl₂·yH₂O may, in particular, be FeCl₂·H₂O (ferrous chloride monohydrate), i.e. y=1.

In the sense used in this specification, in the context of the dehydration step, the terms “dehydration” and “dehydrated” therefore do not require complete dehydration, to provide an anhydrous form, although that possibility is included within the meaning of the word. The dehydration step may therefore more accurately be characterised as a “partial” dehydration step, at least in terms of the change in the hydration of the ferrous chloride.

The temperature treatment to which the FeCl₂·xH₂O is subjected in the dehydration step, may include subjecting the FeCl₂·xH₂O to a temperature in a range of from 70° C. to 200° C., more preferably in a range of from 70° C. to less than 200° C., i.e. at a temperature less than 200° C. but not lower than 70° C. For example, the temperature may be in a range of from 70° C. to 150° C.

The dehydration step may be performed under non-oxidising conditions, i.e. under conditions that avoid oxidation of the FeCl₂·xH₂O. This may include avoiding, or at least limiting, the presence of exogenous oxygen in the dehydration step. This may, in turn, include performing the dehydration step under positive pressure in a steam environment, which steam may be that which is produced as a result of the dehydration of the FeCl₂·xH₂O.

When crystallisation is effected by means of displacement crystallisation, the digestion reagent would typically not be, or be produced using, gaseous HCl produced in the decomposition step, then rather being or being produced using the aqueous HCl solution produced in the displacement crystallisation step.

When the metallic or metal-bearing material comprises iron, in metallic or compound form, such iron would be converted to ferrous chloride in the digestion step and then displaced as ferrous chloride hydrate from the FeCl₂ solution in the displacement crystallisation step.

When the metallic or metal-bearing material comprises metals (M) other than iron, in metallic or compound form, then at least some such metals other than iron would advantageously also be converted to soluble, e.g. divalent, chlorides (M²⁺Cl₂) thereof in the digestion step and would then also, advantageously, be displaced from solution as divalent metal chloride hydrates (M²⁺Cl₂·zH₂O, wherein z>0) thereof in the displacement crystallisation step.

IN ACCORDANCE WITH A THIRD ASPECT OF THE INVENTION IS PROVIDED a method of treating a solid metallic or metal-bearing material, comprising one or more metals in metallic or compound form, to recover one or more of the metals from the metallic or metal-bearing material in metallic or compound form, the method including, in a thermal decomposition step, subjecting FeCl₂·xH₂O, wherein x≥1, more preferably x>1, x most preferably being 4, produced by crystallisation thereof from a FeCl₂ solution produced by oxidative/reductive digestion of the metallic or metal-bearing material, and/or FeCl₂·yH₂O, wherein x>y>0, y preferably being 1, produced by subjecting the FeCl₂·xH₂O to dehydration, to temperature treatment, thus decomposing the FeCl₂·xH₂O or FeCl₂·yH₂O to produce solid ferric oxide (Fe₂O₃) and gaseous HCl.

The gaseous HCl may, in particular, be anhydrous gaseous HCl.

It is noted that, in the context of the thermal decomposition step and the invention generally, it is preferred that it is FeCl₂·xH₂O or FeCl₂·yH₂O that is subjected to thermal decomposition, to the exclusion of FeCl₃. This is since FeCl₃ would, when subjected to thermal decomposition, not decompose to produce gaseous HCl and Fe₂O₃, but would instead sublimate.

Producing the FeCl₂ solution by oxidative/reductive digestion of the metallic or metal-bearing material may have included contacting the metallic or metal-bearing material with a digestion reagent selected from
FeCl₃, typically in aqueous solution,
gaseous HCl,
HCl in aqueous solution, and
optionally, a combination thereof, and
reducing any FeCl₃ in solution, produced from the contacting of the metallic or metal-bearing material with the digestion reagent, to FeCl₂.

The FeCl₂ solution may, for example, be a FeCl₂ solution that has been produced according to the method of the first aspect of the invention.

Crystallisation of FeCl₂·xH₂O from the FeCl₂ solution may have been achieved by conventional methods, e.g. by means of evaporative crystallisation.

More preferably, however, crystallising the FeCl₂·xH₂O from the FeCl₂ solution may have been effected, in accordance with the second aspect of the invention, by displacement crystallisation from a FeCl₂ solution, which may have included contacting a FeCl₂ solution, produced by oxidative/reductive digestion of the metallic or metal-bearing material, with a displacement crystallisation reagent, preferably hydrochloric acid (HCl), most preferably gaseous HCl, that displaced FeCl₂ from solution and thus produced FeCl₂·xH₂O.

The gaseous HCl may, in particular, have been anhydrous gaseous HCl, preferably produced by the thermal decomposition step of the invention.

The use of displacement crystallisation, as characterised above in accordance with the invention, over evaporative crystallisation, is preferred since, in the case of evaporative crystallisation, the pH shift that results from the evaporation of water from an FeCl₂ solution makes the FeCl₂ in the solution significantly more susceptible to oxidation to FeCl₃, which should be avoided in the context of the invention, in light thereof that, as mentioned above, FeCl₃ sublimates when subjected to high temperatures such as those exploited by the invention in the thermal decomposition step that is described herein.

When crystallisation is effected by means of displacement crystallisation, the digestion reagent would typically not be, or would typically not be produced using, gaseous HCl produced in the decomposition step, then rather being or being produced using the aqueous HCl solution that is produced in the displacement crystallisation step.

Furthermore, producing FeCl₂·yH₂O through dehydration of the FeCl₂·xH₂O and subjecting the FeCl₂·yH₂O to thermal decomposition, is preferred. Such dehydration may be effected, as described with reference to the second aspect of the invention, by subjecting the FeCl₂·xH₂O to temperature treatment, at a temperature in a range of from 70° C. to 200° C., more preferably in a range of from 70° C. to less than 200° C., i.e. at a temperature less than 200° C. but not lower than 70° C. For example, the temperature may be in a range of from 70° C. to 150° C.

It is regarded as a particular inventive advantage of the invention that by subjecting FeCl₂·yH₂O to thermal decomposition, an effect of producing anhydrous gaseous hydrochloric acid is inventively achieved and exploited.

The solid FeCl₂·xH₂O, or the FeCl₂·yH₂O, may, for example, be FeCl₂·xH₂O, or FeCl₂·yH₂O, that has been produced according to the method of the second aspect of the invention.

When the metallic or metal-bearing material comprises iron, in metallic or compound form, then such iron would be converted to ferrous chloride, would be displaced from solution as ferrous chloride hydrate, would be dehydrated, and would be decomposed as described.

When the metallic or metal-bearing material comprises metals (M) other than iron, in metallic or compound form, then at least some of such metals other than iron would advantageously also be converted to soluble, e.g. divalent, chlorides (M²⁺Cl₂) thereof, would be displaced from solution as divalent chloride hydrates (M²⁺Cl₂·zH₂O, wherein z>0) thereof, would be partially or fully dehydrated (to produce M²⁺Cl₂·aH₂O, wherein z>a≥0), and would subjected to decomposition as described (to produce anhydrous M²⁺Cl₂).

In contrast to the ferrous chloride hydrate when subjected to decomposition, such other divalent metal chlorides or chloride hydrates would therefore not decompose. They would remain intact, at most being completely dehydrated to their anhydrous divalent chloride forms. In such forms, such metals are soluble and may thus be easily separated from the solid ferric oxide by solid-liquid separation.

IN ACCORDANCE WITH A FOURTH ASPECT OF THE INVENTION IS PROVIDED a method of treating a solid metallic or metal-bearing material, comprising one or more of the metals in metallic or compound form, to recover one or more of the metals from the metallic or metal-bearing material in metallic or compound form, the method including
in an oxidative or reductive digestion step, producing a ferrous chloride (FeCl₂) solution by contacting the metallic or metal-bearing material with a digestion reagent selected from
   ferric chloride (FeCl₃), in aqueous solution
   gaseous hydrochloric acid (HCl),
   HCl in aqueous solution, and
   optionally, a combination of any two or more thereof,
and reducing any FeCl₃ in solution, produced from the contacting of the metallic or metal-bearing material with the digestion reagent, to FeCl₂ in solution;
in a crystallisation step, crystallising a solid ferrous chloride hydrate (FeCl₂·xH₂O, wherein x≥1, preferably x>1, most preferably being 4) from the FeCl₂ solution;
optionally, in a dehydration step, subjecting the FeCl₂·xH₂O to temperature treatment to produce dehydrated ferrous chloride hydrate (FeCl₂·yH₂O, wherein x>y>0, preferably being 1); and
in a thermal decomposition step, subjecting the FeCl₂·xH₂O and/or the FeCl₂·yH₂O to temperature treatment and thus decomposing the FeCl₂·xH₂O and/or the FeCl₂·yH₂O to produce solid ferric oxide (Fe₂O₃) and gaseous HCl.

The oxidative or reductive digestion step may be that of the method of the first aspect of the invention.

Crystallisation of FeCl₂·xH₂O from the FeCl₂ solution may be achieved by conventional methods, e.g. by means of a evaporative crystallisation.

More preferably, however, crystallising the FeCl₂·xH₂O from the FeCl₂ solution may be effected by displacement crystallisation from the FeCl₂ solution (i.e. the crystallisation step may be a displacement crystallisation step), which may include contacting, and saturating, the FeCl₂ solution with a displacement crystallisation reagent, preferably HCl, more preferably HCl in gaseous form, most preferably HCl in anhydrous gaseous form, e.g. gaseous HCl recovered from the thermal decomposition step, thus displacing FeCl₂ from solution and producing the FeCl₂·xH₂O.

In the displacement crystallisation step, the temperature of the FeCl₂ solution may be from 10° C. to 60° C.

When the displacement crystallisation reagent is HCl in gaseous form, the displacement crystallisation may comprise, for example, scrubbing the gaseous HCl with the FeCl₂ solution.

In the displacement crystallisation step, an aqueous solution of HCl (i.e. diluted HCl) may therefore be formed.

When displacement crystallisation is used, the method may include
separating solid FeCl₂·xH₂O, and any other solid metal chloride hydrates that crystallised along with the FeCl₂·H₂O in the crystallisation step (M²⁺Cl₂·zH₂O wherein z≥1, as described below), from the aqueous solution of HCl thus produced; and
using the aqueous solution of HCl as, or in producing, the digestion reagent in the digestion step.

The method may therefore include, in a second separation step, performed after the displacement crystallisation step and before the dehydration step, recovering solid FeCl₂·xH₂O, and any other solid metal chloride hydrates (M²⁺Cl₂·zH₂O, as described herein) that may be present, from the resulting HCl solution by means of solid-liquid separation, thus recovering FeCl₂·xH₂O and any solid M²⁺Cl₂·zH₂O that may have been present.

As mentioned above, the method may also include recycling the HCl solution produced in the displacement crystallisation step to the digestion step of the method and/or using the HCl solution to produce a FeCl₃ solution for use in the digestion step, by reaction of the HCl in the HCl solution with Fe₂O₃, which may be Fe₂O₃ which is produced in the thermal decomposition step of the invention.

It is noted that recycle of the HCl solution produced in the displacement crystallisation step may include recycle of some metal chlorides not converted to metal chloride hydrates, e.g. as a result of low concentration. It is expected that build-up of such metal chloride hydrates would ultimately result in such conversion, once a sufficiently high concentration has been achieved.

The displacement crystallisation step may be that of the method of the second aspect of the invention.

The thermal decomposition step may be that of the third aspect of the invention.

The following statements apply to all of the abovementioned first to fourth aspects of the invention:

The one or more metals comprised by the metallic or metal-bearing material may include one or more of chrome (Cr), copper (Cu), vanadium (V), nickel (Ni), cobalt (Co), zinc (Zn), titanium (Ti), manganese (Mn) and iron (Fe), in metallic and/or compound forms.

Typically, the metallic or metal-bearing material would include at least iron, in a metallic or compound form, and preferably at least one metal (M) other than iron, in a metallic or compound form. Such other metals (M) may for example be one or more of those listed above, other than iron.

In cases in which the metallic or metal-bearing material includes iron, in metallic or compound form, the digestion reagent may comprise at least HCl.

In some embodiments of the invention, the metallic or metal-bearing material may, for example, be one or more of a polyoxide material (containing multiple metal oxides), a polysulphide material (containing multiple metal sulphides), an alloy material, a metal slag material, a metal fines material, and a metallic material.

Thus, metals in the metallic or metal-bearing material may, for example, be in one or more of metal oxide form, metal sulphide form, and metallic from.

In one specific embodiment of the invention, the metal-bearing material may be an ore material. For example, the metal-bearing material may be a titaniferous magnetite ore material, e.g. a vanadium-containing titaniferous magnetite ore material. Generally, it is envisaged that the invention may find application to any metal sulphide and/or metal oxide bearing ore material, particularly those comprising iron in a metallic or compound form.

Depending on the composition of the metal-bearing material, the FeCl₂ solution may therefore contain, in addition to FeCl₂, other metal chlorides, typically at least other divalent metal chlorides (M²⁺Cl₂), but not excluding monovalent metal chlorides, in solution, e.g. CuCl₂ or Cu₂Cl₂.

Thus, the digestion step may have to effect that at least some metals contained in the metallic or metal-bearing material in metallic or metal compound form, are converted to metal chlorides (FeCl₂ and, if other metals (M) are present, M²⁺Cl₂) in solution, contained in the FeCl₂ solution. This is desired.

The digestion step may be performed at a temperature of from 10° C. to 120° C.

If an FeCl₃ digestion reagent is used in the digestion step, it may be in solution. Typically, it may be in aqueous solution at a concentration of from 5 wt % to 70 wt %.

It is noted that in order to produce FeCl₃ in solution for use as the digestion reagent in the digestion step, solid Fe₂O₃ may be used in conjunction with HCl, thus producing a FeCl₃ solution in the digestion step, instead of producing it separately as a feed to the digestion step.

HCl, when used as digestion reagent in the digestion step, may be in solution, and may be produced as described in accordance with the first aspect of the invention. Typically, it may be in aqueous solution at a concentration of from 5 wt % to 40 wt %, more preferably 30% to 36%, e.g. 33%.

Alternatively, the HCl, when used as digestion reagent in the digestion step, may be gaseous HCl, as described in accordance with the first aspect of the invention.

The digestion reagent may therefore be, for example,
gaseous HCl, e.g. produced in the thermal decomposition step;
an aqueous solution of HCl, e.g. produced by scrubbing gaseous HCl e.g. produced in the thermal decomposition step with water;
an aqueous solution of HCl, e.g. produced by scrubbing gaseous HCl e.g. produced in the thermal decomposition step with an aqueous suspension or slurry of the solid metallic or metal-bearing material;
an aqueous solution of FeCl₃, produced by contacting solid Fe₂O₃ e.g. produced in the thermal decomposition step with an aqueous solution of HCl produced by scrubbing gaseous HCl e.g. produced in the thermal decomposition step with water; or
an aqueous solution of FeCl₃, produced by scrubbing gaseous HCl e.g. produced in the thermal decomposition step with an aqueous suspension of solid Fe₂O₃ e.g. produced in the thermal decomposition step.

When crystallisation is effected by means of displacement crystallisation, the digestion reagent would typically not be, or would not be produced using, gaseous HCl produced in the decomposition step, then rather being or being produced using the aqueous HCl solution produced in the displacement crystallisation step.

Metallic iron may be used as the reducing agent.

In using metallic iron as the reducing agent, in addition to reduction of Fe³⁺ to Fe²⁺ (i.e. FeCl₃ to FeCl₂), other metals may be reduced, possibly to solid metallic form, thus rendering such metals readily recoverable by solid-liquid separation.

Reduction may only be required if there is FeCl₃ in solution that forms from treatment of the metallic or metal-bearing material with the digestion reagent.

The method may include, in a first separation step performed after the digestion step, separating solids from the FeCl₂ solution by means of solid-liquid separation, thus recovering the FeCl₂ solution (inclusive of other divalent metal chlorides in solution) substantially free of solids.

When the FeCl₂ solution contains other metal chlorides (M²⁺Cl₂) in solution, the crystallisation step may form, in addition to solid FeCl₂·xH₂O, other solid metal (M) chloride hydrates (M²⁺Cl₂·zH₂O, wherein z>0 and M may, for example, be selected from one or more of chrome (Cr), copper (Cu), vanadium (V), nickel (Ni), cobalt (Co), zinc (Zn), titanium (Ti), and manganese (Mn)).

As mentioned above with reference to the crystallisation step when the crystallisation step comprises displacement crystallisation, the method may include, in a second separation step, performed after the crystallisation step and before the dehydration step, recovering solid FeCl₂·xH₂O, and any solid M²⁺Cl₂·zH₂O that may be present.

The dehydration step is preferably performed.

The dehydration step may be effected, as described with reference to the second aspect of the invention, by subjecting the FeCl₂·xH₂O, and any M²⁺Cl₂·zH₂O that may be present, to temperature treatment, at a temperature in a range of from 70° C. to 200° C., more preferably in a range of from 70° C. to less than 200° C., i.e. at a temperature less than 200° C. but not lower than 70° C. For example, the temperature may be in a range of from 70° C. to 150° C.

Thus, FeCl₂·yH₂O and, if M²⁺Cl₂·zH₂O was present, dehydrated solid divalent chloride hydrate or anhydrous solid divalent chloride of the other metal (M²⁺Cl₂·aH₂O wherein z>a≥0) may be produced.

The method may then comprise subjecting the FeCl₂·yH₂O and any M²⁺Cl₂·aH₂O produced by the dehydration step, to thermal decomposition.

The dehydration step may be performed under non-oxidising conditions. This may include avoiding, or at least limiting, the presence of exogenous oxygen in the drying step. This may, in turn, include performing the dehydration step under positive pressure in a steam environment, which steam may be that which is produced as a result of the dehydration of the FeCl₂·xH₂O.

As indicated above, when solid M²⁺Cl₂·zH₂O, in addition to FeCl₂·xH₂O, is recovered from the crystallisation step, such solid M²⁺Cl₂·zH₂O would also be subject to dehydration in the dehydration step, along with the FeCl₂·xH₂O, such that, in addition to FeCl₂·yH₂O, dehydrated solid divalent chloride hydrate and/or anhydrous solid divalent chloride of the other metal (M²⁺Cl₂·aH₂O, wherein z>a≥0, thus including anhydrous forms when a=0) are also produced in the dehydration step.

The thermal decomposition step may be performed at a temperature of from 200° C. to 600° C., more preferably at a temperature above 200° C., up to 600° C.

The thermal decomposition step may be performed under oxidising conditions, i.e. in the presence of oxygen which may be supplied, for example, by air.

The gaseous HCl that is produced in the thermal decomposition step may be substantially dry, i.e. devoid of moisture (anhydrous).

Reactions that occur in the drying (dehydration) and thermal decomposition steps therefore comprise
(i) Drying (dehydration) at temperatures described above, under non-oxidising conditions

FeCl₂·4H₂O (s)→FeCl₂·H₂O (s)+3H₂O (g)
(ii) Thermal decomposition under oxidising conditions, in the presence of oxygen (½O₂) supplied by air, at temperatures described above

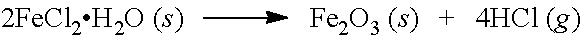

As mentioned above, when solid M²⁺Cl₂·zH₂O, in addition to FeCl₂·xH₂O, is recovered from the crystallisation step, and the dehydration step is performed and, in addition to FeCl₂·yH₂O, solid M²⁺Cl₂·aH₂O is produced in the dehydration step, such solid M²⁺Cl₂·zH₂O and/or M²⁺Cl₂·aH₂O would be subjected to temperature treatment in the thermal decomposition step along with the FeCl₂·xH₂O/FeCl₂·yH₂O.

Thermal decomposition of FeCl₂·xH₂O/FeCl₂·yH₂O would occur to the exclusion of solid M²⁺Cl₂·zH₂O and/or M²⁺Cl₂·aH₂O, however which M²⁺Cl₂·zH₂O and/or M²⁺Cl₂·aH₂O would, to the extent that they were not already fully dehydrated, become fully dehydrated in the thermal decomposition step and thus remain as fully dehydrated solid M²⁺Cl₂ (i.e. a=0) post thermal decomposition of the FeCl₂·xH₂O/FeCl₂·yH₂O (preferably FeCl₂·yH₂O) to Fe₂O₃ and gaseous HCl. As will be appreciated from the foregoing discussions, however, it is preferred that only FeCl₂·yH₂O and M²⁺Cl₂·aH₂O are subjected to the thermal decomposition step, to produce ferric oxide, anhydrous HCl gas and solid M²⁺Cl₂.

Therefore, the thermal decomposition step would typically produce a mixture of solid Fe₂O₃ and solid M²⁺Cl₂, in addition to gaseous HCl which is then used as described herein.

The method may then include, in a third separation step, dissolving the M²⁺Cl₂ in water, and performing a solid-liquid separation to recover the insoluble Fe₂O₃ from the resulting solution of M²⁺Cl₂.

In the resulting solution of M²⁺Cl₂, metals (M), other than iron, that were originally contained in the metallic or metal-bearing material, have thus been liberated from the matrix in which they were held in the metallic or metal-bearing material, which matrix may have included iron. Such other metals may now be recovered by conventional methods, e.g. hydrometallurgical methods, from the resulting solution.

The method thus also produces saleable Fe₂O₃ and products suitable for recycle to earlier method steps. For example, and significantly it is noted that the thermal decomposition of FeCl₂·xH₂O/FeCl₂·yH₂O (preferably FeCl₂·yH₂O) by means of temperature treatment releases gaseous HCl, desirably in an anhydrous form particularly when FeCl₂·yH₂O is subjected to thermal decomposition.

The method may include recycling this HCl gas to be used in the crystallisation step, when performed as displacement crystallisation. Alternatively, it may be recycled to the digestion step, to be used as digestion reagent or in producing digestion reagent.

Furthermore, as noted earlier, the Fe₂O₃ may be reacted with HCl solution from the displacement crystallisation step, and more specifically from the second separation step, to produce a FeCl₃ solution for use in the digestion step.

It is regarded as a particular advantage, and inventive feature, of the invention as described, that the production of FeCl₂·xH₂O and subsequent dehydration to FeCl₂·yH₂O enables, through subsequent decomposition of the partially dehydrated FeCl₂·yH₂O, the production of HCl in gaseous form which is, as will be appreciated, concentrated and undiluted HCl which, in addition, is in the context of the invention substantially dry, i.e. devoid of moisture (anhydrous). This is in stark contrast to conventional methods exploiting HCl in the digestion of solid metal-bearing feedstocks, which unavoidably form dilute solutions of HCl due to water balances that are unfavourable to the production of concentrated HCl, and even to the production of desired concentrations of diluted HCl. For example, while the maximum concentration of HCl at room temperature is around 33% v/v, existing methods exploiting HCl rarely achieve a regeneration of diluted HCl above 18% v/v. The present invention addresses this elegantly, by taking a route of iron precipitation as FeCl₂·xH₂O, partial dehydration thereof to produce FeCl₂·yH₂O, and decomposition thereof in turn to produce undiluted gaseous HCl for use in earlier method steps.

THE INVENTION EXTENDS, AS A FIFTH ASPECT THEREOF, TO a process for performing the method of the first to fourth aspects of the invention, which process includes process stages and process operations corresponding to and for performing the respective method steps.

### DETAILED DESCRIPTION OF AN ILLUSTRATIVE EMBODIMENT

THE INVENTION WILL NOW BE DESCRIBED IN MORE DETAIL with reference to the accompanying diagrammatic drawing which shows a process according to the fifth aspect of the Invention.

Referring to the drawing, reference numeral 10 generally indicates a process according to the fifth aspect of the Invention, for performing a method of the first to fourth aspects of the Invention.

The process 10 includes the following process stages:
an oxidative/reductive digestion stage 12;
a reduction stage 14;
a first separation stage 16;
a displacement crystallisation stage 18;
a second separation stage 20;
a drying stage 22;
a thermal decomposition stage 24;
a third separation stage 26;
a ferric chloride generation stage 28; and
a metals recovery stage 30.

In the process 10, the following feed, transfer, withdrawal, and recycle lines are identified:
feed line 32;
feed line 34
feed line 36
transfer line 38;
feed line 40;
transfer line 42;
withdrawal line 44;
transfer line 46;
feed line 48;
recycle line 50;
transfer line 52;
recycle line 54;
recycle line 56;
transfer line 58;
transfer line 60;
transfer line 62;
transfer line 64;
transfer line 66;
recycle line 70;
withdrawal line 72;
feed line 74; and
recycle line 76.

In using the process 10 to perform the method of the first to fourth aspects of the Invention, a metallic or metal-bearing material is fed to the digestion stage 12 along feed line 32, along with one or a combination of a solution of FeCl₃ and a solution of HCl, respectively along feed line 34 and/or recycle line 70 and along feed line 36 and/or recycle line 54. Alternative/additional approaches to providing a solution of HCl and a solution of FeCl₃ to the digestion stage 12, with reference to recycle lines 54, 70 and 76, are discussed below.

Oxidative/reductive digestion of the metallic or metal-bearing material proceeds in the digestion stage 12, and produces a FeCl₂ solution, possibly containing residual FeCl₃, and possibly containing one or more other metal (M) chlorides, e.g. chlorides of copper (Cu), vanadium (V), nickel (Ni), cobalt (Co), zinc (Zn), titanium (Ti), and manganese (Mn).

The FeCl₂ solution is transferred from the digestion stage 12 to the reduction stage 14 along transfer line 38, where it is contacted with a reducing agent that is fed to the reduction stage 14 along feed line 40.

The FeCl₂ solution is then transferred from the reduction stage 14 to the first separation stage 16 along transfer line 42, where solids contained in the FeCl₂ solution are separated from the FeCl₂ solution and are withdrawn along withdrawal line 44.

The recovered FeCl₂ solution is then passed from the first separation stage 16 to the displacement crystallisation stage 18 along transfer line 46. Here the FeCl₂ solution is contacted with gaseous HCl which is fed to the displacement crystallisation stage 18 along feed line 48 and/or along recycle line 50.

Contacting the FeCl₂ solution with gaseous HCl in the displacement crystallisation stage 18 produces solid FeCl₂·xH₂O, and solid M²⁺Cl₂·zH₂O if there are other metal (M) chlorides present in the FeCl₂ solution, (x,z≥1), in an aqueous solution of HCl (i.e. diluted HCl). Typically, the value of x would be 4, and therefore the solid FeCl₂·xH₂O would be FeCl₂·4H₂O (i.e. ferrous chloride tetrahydrate).

The solid FeCl₂·xH₂O, solid M²⁺Cl₂·zH₂O, if present, and aqueous solution of HCl are transferred to the second separation stage, along transfer line 52, where the solid FeCl₂·xH₂O and solid M²⁺Cl₂·zH₂O, if present, are separated from the aqueous solution of HCl and are withdrawn along transfer line 58. The aqueous solution of HCl is recycled along recycle line 54 to the digestion stage 12 and/or along line 56 to the FeCl₃ generation stage 28. The solid FeCl₂·xH₂O and solid M²⁺Cl₂·zH₂O, if present, are transferred to the dehydration stage 22 along transfer line 58.

It is noted that recycle of the aqueous solution of HCl may include recycle of some metal chlorides not converted to metal chloride hydrates, e.g. as a result of low concentration. Build-up of such metal chloride hydrates would ultimately result in such conversion, once a sufficiently high concentration has been achieved.

In the dehydration stage 22, the solid FeCl₂·xH₂O and solid M²⁺Cl₂·zH₂O, if present, are subjected to dehydration in a non-oxidising environment, using temperature treatment at a temperature below 200° C. but not less than 70° C., more preferably at a temperature in a range of from 70° C. and 150° C., thus producing solid FeCl₂·yH₂O and solid M²⁺Cl₂·aH₂O, if present, (x>y≥0; z>a≥0).

More specifically, the solid FeCl₂·xH₂O and solid M²⁺Cl₂·zH₂O, if present, are fed into, and through, a non-vented vessel in which the temperature treatment is carried out, thus producing a slight positive pressure relative to atmospheric pressure inside the vessel resulting from steam that is formed inside the vessel due to the temperature treatment and the resulting dehydration of the FeCl₂·xH₂O and M²⁺Cl₂·zH₂O, which steam serves to displace oxygen that may be present in the vessel, e.g. in the form of air, thus avoiding oxidisation of the ferrous chloride.

The solid FeCl₂·yH₂O and solid M²⁺Cl₂·aH₂O are transferred, along transfer line 60, to the thermal decomposition stage 24, in which the solid FeCl₂·yH₂O and solid M²⁺Cl₂·aH₂O are subjected to temperature treatment to decompose the solid FeCl₂·yH₂O to produce solid Fe₂O₃ and HCl gas, to the exclusion of the solid M²⁺Cl₂·aH₂O which remains intact and is therefore not decomposed, but would typically be dehydrated so that in any case of M²⁺Cl₂·aH₂O where a≥1 being present in the decomposition stage such M²⁺Cl₂·aH₂O would be converted to anhydrous M²⁺Cl₂ (i.e. a=0). The temperature treatment is effected under conditions that favour the thermal decomposition of FeCl₂·yH₂O over that of M²⁺Cl₂·aH₂O, and it is in fact so that no thermal decomposition of the M²⁺Cl₂·aH₂O (z>a≥0) would take place at any temperature at which decomposition of the FeCl₂·yH₂O is performed. The temperature treatment in the thermal decomposition stage 24 is performed at a temperature above 200° C., but not higher than 600° C., under oxidising conditions, i.e. in the presence of oxygen, e.g. being supplied by air.

The HCl gas produced in the thermal decomposition stage 24 is recovered and is recycled along recycle line 50 to the displacement crystallisation stage 18.

To favour or effect oxidising conditions in the thermal decomposition stage, a blower may be employed to blow air into the thermal decomposition stage and thus also expel gaseous hydrochloric acid from the thermal decomposition stage, for recovery and use as described herein.

It will be appreciated that gaseous HCl is concentrated, i.e. undiluted and thus substantially pure, HCl which, in addition, is substantially dry (i.e. devoid of moisture, and thus anhydrous). Thus, the process as described enables the achievement of a favourable water balance that, in turn, enables the production of concentrated substantially dry HCl in gaseous form, for use upstream in the process. This is in contrast to existing processes that exploit HCl in metal recovery operations, which produce diluted HCl solutions, rarely at concentrations higher than 18% v/v.

In the absence of dehydration of the FeCl₂·xH₂O, the gaseous HCl produced from the thermal decomposition stage 24 would be moist/dilute (i.e. contain water vapour), which would not be effective in displacing dissolved FeCl₂ in the manner described in the displacement crystallisation stage 18. The inventive approach that the invention follows therefore further avoids any need for an evaporation operation to recover gaseous HCl for use in the displacement crystallisation stage 18.

The solid Fe₂O₃ and solid M²⁺Cl₂ are transferred to the third separation stage 26, along transfer line 62, in which the solid M²⁺Cl₂ is dissolved in water to produce a M²⁺Cl₂ solution, and solid-liquid separation is carried out to recover the M²⁺Cl₂ solution and solid Fe₂O₃.

The M²⁺Cl₂ solution is transferred to the metals recovery stage 30 along transfer line 64, for recovery of the metals contained therein.

The Fe₂O₃ is withdrawn, as a saleable product, along withdrawal line 72, and/or is transferred, along transfer line 66, to the FeCl₃ generation stage 28 where it is contacted with HCl that is fed to the generation stage 28 along feed line 74 or that is recycled to the generation stage 28 along recycle line 56, and/or is recycled to the digestion stage 12 along recycle line 76 where it is contacted with HCl to produce a FeCl₃ solution in situ.

The generated (re-generated) FeCl₃ is then recycled from the generation stage 28 to the digestion stage 18.

### EXAMPLES

### Example 1—Beneficiation of Mixed Oxide and Sulphide Copper Concentrate

The ore concentrate beneficiated in this example, has a composition as set out in Table 1 below.
1. 100 g concentrate (refer to table 1) as received from the mine (milled to −75 um) was digested with 250 g FeCl₃ (43 wt %) solution, 55 g HCl (33 wt %) solution and 100 ml water for 4 hours at 105° C. in a reflux glass beaker.

TABLE 1
Chemical composition of feed

| | Total | Acid | | | | | |
|---|---|---|---|---|---|---|---|
| Place | Cu | sol Cu | S | Al₂O₃ | K₂O | SiO₂ | Fe |
| UIS | 26.6% | 5.01% | 8.99% | 7.43% | 5.52% | 29.9% | 7.33% |

2. After oxidative digestion of the above concentrate major soluble chlorides FeCl₂, CuCl₂ and Cu₂Cl₂ were produced in solution. Via filtration, the water-soluble fraction was separated from the insoluble fraction. The insoluble fraction comprised 51 g (30%, or 16 g, moisture) and, after washing and drying at 110° C., was found to comprise sulphur, silicates and other insolubles (refer to table 2). Referring to the chemical composition of the insoluble fraction, it follows that 99.6% of the available Cu was extracted.

TABLE 2
Chemical composition of insolubles

| Place | Cu | S | Al₂O₃ | K₂O | SiO₂ | Fe |
|---|---|---|---|---|---|---|
| UIS | 0.087% | 18% | 11.75% | 7.5% | 55.5% | 0.7% |

3. Approximately 400 ml filtrate (470 g) was obtained after filtration. To this filtrate, 19.8 g iron powder was added while stirring. After 30 minutes, the resulting reduction reaction was completed.
4. The copper cement, resulting from the reduction, was washed, filtered and dried, and 27.4 g Cu was recovered. It is noted that this copper can be pressed and melted or used to produce CuSO₄·5H₂O crystals.
5. The remaining filtrate, approximately 350 ml (470 g), was used as a scrubbing solution to scrub 84 g of HCl gas (originating from the decomposition step 8, below). During the scrubbing of the HCl gas, the temperature of the solution was kept at 30-35° C.
6. 228 g of FeCl₂·4H₂O crystals were formed in step 5. These were filtered from the remaining HCl solution (326 g).
7. These crystals were dried at 150° C. to give approximately 166 g FeCl₂·H₂O (s). This dried product was milled in situ to −2 mm.
8. The milled product was then heated in air at 400° C. At this temperature, all the FeCl₂·H₂O was oxidized into Fe₂O₃ (s) and HCl(g).
9. 91.5 g of Fe₂O₃ was recovered. 38.5 g can be sold while 53 g is recycled with 326 g HCl solution (step 6), 18 g new HCl (33 wt %) solution as a top reagent and 108 g water. To this 100 g of feed may be added to restart the next digestion run.

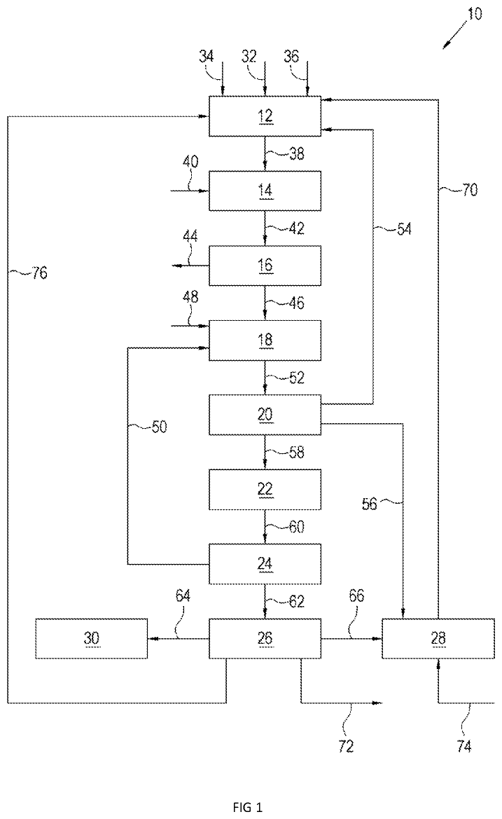

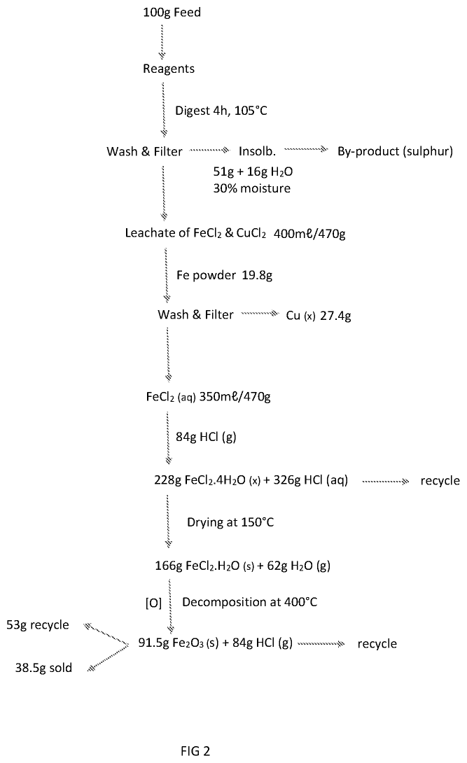

For more information, refer to FIG. 2 as well.

### Example 2—Beneficiation of Nickel Sulphide Concentrate

The ore concentrate beneficiated in this example, has a composition as set out in Table 3 below.

TABLE 3
Chemical composition of feed

| | | Insolubles | Digestion |
|---|---|---|---|
| Major oxides | Feed | (62% of feed) | efficiency |
| SiO₂ | 10.8% | 17.6% | |
| Fe (total) | 30.4% | 23% | 52.7% |
| MgO | 5.6% | 5.6% | |
| Co | 0.5% | 0.23% | 71.25% |
| Cu | 5.1% | 0.11% | 98.65% |
| Ni | 7.73% | 0.26% | 97.9% |
| S | 29.8% | 52.5%* | 110% |
| Ag | 15 ppm | 5.2 ppm | |
| Au | 0.96 ppm | 1.5 ppm | |
| Ir | 0.2 ppm | 0.41 ppm | |
| Os | 2.3 ppm | 4.2 ppm | |
| Pd | 16.6 ppm | 30 ppm | |
| Pt | 7.4 ppm | 11.4 ppm | |
| Rh | 1.13 ppm | 1.48 ppm | |
| Ru | 1.17 ppm | 1.8 ppm | |
| Total PGM's | | 56 ppm | |

*Note:
If the S of the insoluble fraction is floated off, the PGM's > 100 ppm

TABLE 4
Morphology of the feed

| | | Chalco- | Pent- | | Actino- | Pyrrho- |
|---|---|---|---|---|---|---|
| Phases | Pyrite | pyrite | landite | Talc | lite | tite |
| Feed | 23.04% | 14.21% | 14.69% | 39.07% | 1.1% | 3.1% |
| FeCl₃ | Insoluble | Soluble | Soluble | Insoluble | Insoluble | Soluble |

Note:
These values are semi quantitative

1. To 100 g concentrate (−45 μm), 85 g Fe₂O₃ (recycled) was added. This feed was digested with 400 ml HCl(c), approximately 33%, via reflux at 105° C. for 4 hours.
2. Directly after digestion, while the solution was still warm, the slurry (including insoluble) was pumped through a tank containing an excess of scrap Fe. This served to neutralize excess HCl, reduce excess FeCl₃ into FeCl₂ and cement Cu. Approx 6 g of Fe scrap was used in this step.
3. The slurry was then filtered and washed to produce 62 g of insolubles plus 5 g of Cu-cement and 370 ml filtrate.
4. The insolubles together with the copper cement was treated with a dilute solution of H₂SO₄ and HNO₃ to produce a CuSO₄ solution. After filtration and wash, the CuSO₄ can be crystallized into CuSO₄·5H₂O while the insolubles contain the upgraded PGM's.
5. The 370 ml filtrate was used to scrub approximately 100 g HCl(g). The temperature was kept between 15-20° C. The scrubbing of the HCl(g) displaced the ferrous, nickel and cobalt chlorides from the solution, forming solid hydrated crystals thereof. The resulting solution contained approximately 30-36% HCl.
6. After filtration of the crystals, the crystals were washed with a new filtrate solution to rid it from the HCl(c) background. Approximately 95% of the ferrous and 70% of the Ni/Co crystals were obtained this way. The balance was recycled with the HCl solution back to digestion and would build-up in further runs where more will crystallize as the concentrations increase.
7. The washed crystals were dried at 150° C. while clean steam was produced.
8. The dried crystals were then decomposed at 400° C. to produce Fe₂O₃, anhydrous Ni(Co)Cl₂ and HCl(g) to be recycled to step 5.
9. Cold water was added to the Fe₂O₃ to dissolve the Ni(Co)Cl₂. After filtration and wash, the excess Fe₂O₃ can be sold while the Ni(Co)Cl₂ can beneficiated from solution.

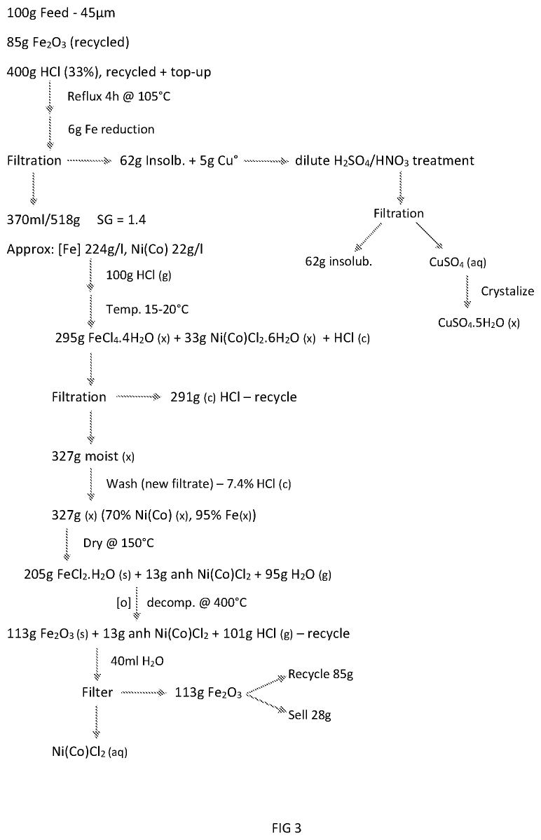

For more information, refer to FIG. 3 as well.

1. A method of treating a solid metallic or metal-bearing material, comprising one or more metals in metallic or compound form, to recover one or more of the metals from the metallic or metal-bearing material in metallic or compound form, the method including
in an oxidative or reductive digestion step, producing an aqueous ferrous chloride (FeCl₂) solution by contacting the metallic or metal-bearing material with a digestion reagent selected from
gaseous hydrochloric acid (HCl),
HCl in aqueous solution, and
an aqueous solution of ferric chloride (FeCl₃) produced by reacting iron (III) oxide (Fe₂O₃) with HCl, in aqueous medium,
and reducing any FeCl₃ in solution, produced from the contacting of the metallic or metal-bearing material with the digestion reagent, to FeCl₂ in solution;
in a crystallisation step, crystallising a solid ferrous chloride hydrate (FeCl₂·xH₂O, wherein x>1) from the FeCl₂ solution;
in a dehydration step, subjecting the FeCl₂·xH₂O to temperature treatment in a non-oxidising environment at a temperature from 70° C. to 150° C., to produce dehydrated solid ferrous chloride hydrate (FeCl₂·yH₂O, wherein x>y>0); and
in a thermal decomposition step, subjecting the FeCl₂·yH₂O to temperature treatment in an oxidising environment at a temperature above 200° C. but not higher than 600° C. and thus decomposing the FeCl₂·yH₂O to produce solid ferric oxide (Fe₂O₃) and anhydrous gaseous HCl.

2. The method according to claim 1, wherein the digestion reagent is
gaseous HCl, produced in the thermal decomposition step;
an aqueous solution of HCl, produced by scrubbing gaseous HCl produced in the thermal decomposition step with water;
an aqueous solution of HCl, produced by scrubbing gaseous HCl produced in the thermal decomposition step with an aqueous suspension or slurry of the solid metallic or metal-bearing material;
an aqueous solution of FeCl₃, produced by contacting solid Fe₂O₃ produced in the thermal decomposition step with an aqueous solution of HCl produced by scrubbing gaseous HCl produced in the thermal decomposition step with water; or
an aqueous solution of FeCl₃, produced by scrubbing gaseous HCl produced in the thermal decomposition step with an aqueous suspension of solid Fe₂O₃ produced in the thermal decomposition step.

3. The method according to claim 1, wherein crystallising the FeCl₂·xH₂O from the FeCl₂ solution is effected by means of displacement crystallisation, by contacting, and saturating, the FeCl₂ solution with gaseous HCl produced in the thermal decomposition step, thus producing solid FeCl₂·xH₂O in an aqueous solution of HCl.

4. The method according to claim 3, which includes
separating solid FeCl₂·xH₂O, and any other solid metal chloride hydrates that crystallised along with the FeCl₂·H₂O in the crystallisation step, from the aqueous solution of HCl thus produced; and
using the aqueous solution of HCl as, or in producing, the digestion reagent in the digestion step.

5. The method according to claim 1, wherein
the metals of the metallic or metal bearing material include iron (Fe) and one or more other metals (M) selected from chrome (Cr), copper (Cu), vanadium (V), nickel (Ni), cobalt (Co), zinc (Zn), titanium (Ti), manganese (Mn), in metallic or compound forms selected from metal oxide form and metal sulphide form;
the FeCl₂ solution thus contains, in addition to FeCl₂, one or more additional metal chlorides (M²⁺Cl₂, wherein M is selected form chrome (Cr), copper (Cu), vanadium (V), nickel (Ni), cobalt (Co), zinc (Zn), titanium (Ti), and manganese (Mn)), in solution; and
the crystallisation step thus forms, in addition to FeCl₂·xH₂O, one or more other solid metal chloride hydrates (M²⁺Cl₂·zH₂O, wherein M is selected from one or more of chrome (Cr), copper (Cu), vanadium (V), nickel (Ni), cobalt (Co), zinc (Zn), titanium (Ti), and manganese (Mn), and z>0).

6. The method according to claim 1, which includes,
in a first separation step, performed after the digestion step, separating solids from the FeCl₂ solution by means of solid-liquid separation, thus recovering the FeCl₂ solution substantially free of solids; and
in a second separation step, performed after the crystallisation step and before the dehydration and decomposition steps, recovering solid FeCl₂·xH₂O and any solid M²⁺Cl₂·zH₂O that crystallised with the FeCl₂·xH₂O in the crystallisation step.

7. The method according to claim 6, wherein, in the dehydration step recovered solid M²⁺Cl₂·zH₂O also subjected to dehydration, along with recovered FeCl₂·xH₂O, thereby producing, in addition to FeCl₂·yH₂O, dehydrated other solid metal chloride hydrates or anhydrous metal chlorides (M²⁺Cl₂·aH₂O, wherein and z>a≥0).

8. The method according to claim 7, wherein
solid M²⁺Cl₂·aH₂O recovered from the dehydration step is subjected to temperature treatment in the thermal decomposition step along with the FeCl₂·yH₂O; and
thermal decomposition of FeCl₂·yH₂O occurs to the exclusion of solid M²⁺Cl₂·aH₂O, of which hydrates thereof are fully dehydrated in the thermal decomposition step, thus producing a mixture of solid Fe₂O₃ and solid other anhydrous metal chlorides (M²⁺Cl₂).

9. The method according to claim 1, wherein the thermal decomposition step is performed at a temperature above 200° C. but not higher than 600° C.

10. The method according to claim 1, wherein x=4 and y=1.
